(19) United States
(12) Patent Application Publication
(10) Pub. No.: US 2026/0188057 A1
(43) Pub. Date: Jul. 2, 2026

(54) MANAGING VEHICLE DIAGNOSTICS

(71) Applicant: Tesla, Inc., Austin, TX (US)

(72) Inventors: John Burns, Austin, TX (US); Sam Charles, Austin, TX (US); Derek Bednarski, Austin, TX (US); Kia Baratzadeh, Austin, TX (US); Stephen Nees, Austin, TX (US)

(21) Appl. No.: 18/865,446

(22) PCT Filed: May 22, 2023
(86) PCT No.: PCT/US2023/067313

§ 371 Date: Nov. 13, 2024

Related U.S. Application Data
(60) Provisional application No. 63/365,263, filed on May 24, 2022.

(51) Int. Cl. G07C 5/00; G06Q 10/20

(52) U.S. Cl. CPC G07C 5/008; G06Q 10/20; G07C 5/006

(57) ABSTRACT

A method for managing vehicle servicing may capture at least one of a user concern/input related to a requested service or observed vehicle operational parameters. A method for managing vehicle servicing may conduct diagnosis and filtering based on the user input to identify a set of corrective actions to be performed and pre-service steps that may be required prior to service, wherein the diagnosis and filtering correspond to a suite of diagnostic services to be deployed and implemented. A method for managing vehicle servicing may transmit at least one processing result associated with the execution of the suite of diagnostic services and may obtain approval of the service request by a user and schedule the service.

### CROSS-REFERENCE TO RELATED APPLICATION

This application claims the benefit of U.S. Provisional Application No. 63/365,263, entitled “MANAGING VEHICLE DIAGNOSTICS”, and filed on May 24, 2022, which is hereby incorporated by reference in its entirety.

### BACKGROUND

Generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet). In such embodiments, the originating computing device can collect or generate information and provide the collected information to the server computing device for further processing or analysis.

Generally described, a variety of vehicles, such as electric vehicles, combustion engine vehicles, hybrid vehicles, etc., can be configured with various sensors and components to facilitate operation of the vehicle or management of one or more systems include in the vehicle. In certain scenarios, a vehicle owner or vehicle user may wish to schedule services with a service technician prior to any form of initial diagnostics or inspection by the service technician. For example, a vehicle owner/user may be provided functionality to self-schedule service appointments.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of one or more embodiments of the system and methods provide several advantages over traditional systems and methods.

In some aspects, the techniques described herein relate to a method for managing vehicle servicing including: capturing or receiving at least one of a user concern/input related to a requested service or observed vehicle operational parameters; causing, execution of a suite of diagnostic services responsive to the received at least one user input; transmitting at least one processing results associated with execution of the suite of diagnostic service; and determining whether to offer a first service request or obtaining approval of the service request by a user and scheduling of at least one service based, at least in part, on the at least one processing result.

Another aspect is a method of capturing at least one user input, wherein the at least one user input corresponds to at least one of a requested service or an observed vehicle operational parameters; causing, at a vehicle, execution of a suite of diagnostic services responsive to the captured at least one user input; transmitting, at the vehicle, at least one processing result associated with execution of the suite of diagnostic services; and obtaining approval of a service request by a user and scheduling of at least one service based, at least in part, on the at least one processing result.

Still another aspect is a method for managing vehicle servicing. This method includes: receiving at least one of a user input related to a vehicle component; causing, at a vehicle, execution of a suite of diagnostic services responsive to the received at least one user input; transmitting at least one processing results associated with execution of the suite of diagnostic services; and determining whether to offer a first service request.

### BRIEF DESCRIPTION OF THE DRAWINGS

These and other features, aspects and advantages of the present invention are described herein with reference to drawings of preferred embodiments, which are intended to illustrate, and not to limit, the present invention.

FIG. 1 depicts a block diagram of an illustrative environment for providing configuration and management of a suite of diagnostics services based on customer input in accordance with one or more aspects of the present disclosure;

FIG. 2 depicts an illustrative architecture for implementing a vehicle diagnostic service in accordance with aspects of the present application;

FIG. 3 is a block diagram of the environment of FIG. 1 illustrating the provisioning and execution of the suite of diagnostic services in accordance with aspects of the present application;

FIG. 4 is a flow chart describing a routine for providing vehicle diagnostic management service according to one or more embodiments as disclosed herein;

FIG. 5 is a flow chart describing a routine for providing vehicle diagnostic management service according to one or more embodiments as disclosed herein; and

FIG. 6 is a flow chart describing a routine for providing vehicle diagnostic management service according to one or more embodiments as disclosed herein.

### DETAILED DESCRIPTION

Generally described, one or more aspects of the present disclosure relate to the configuration and management of diagnostic services associated with vehicles. Illustratively, the diagnostic services may be responsive to client/customer input, such as in the identification of an operating concern or in anticipation of a scheduled service appointment for the vehicle. By way of illustrative example, aspects of the present application correspond to the selection, deployment and execution of one or more diagnostic services or diagnostic applications to collect and transmit operational or measured attributes of a vehicle. The one or more diagnostic services or diagnostic applications may be generally referred to as a suite of diagnostic services.

Generally, traditional approaches to performing a vehicle service is based on onsite vehicle inspection, vehicle diagnosis, and vehicle repair by a technician. More specifically, a customer tenders a vehicle to a service center that provides the technician with physical access to the vehicle, and the customer explains about the vehicle. Then, based on the customer's explanation, the technician performs a diagnosis and repairs the vehicle. These traditional approaches can cause inefficiency for both the customer and a vehicle service center. In one aspect, the customer has to visit the service center (or a technician has to be in physical proximity to the vehicle). In another aspect, a technician performs a vehicle diagnosis based on the customer's explanation. In this aspect, the diagnosis results can be different depending on the technician's knowledge or level of experience. In another aspect, the technician performs the vehicle repair based on the diagnosis result. In this aspect, since the diagnosis result can be different depending on the technician's knowledge, the vehicle repair result can be different. For example, a technician may require a diagnosis and perform a vehicle repair, but the diagnosis result can be incorrect because the technician might not understand the customer's explanation. Further, the customer may have to reschedule the service appointment and perform the above vehicle service process. In another aspect, the repair only requires a software update on the vehicle, however, the customer may have to perform the above vehicle service process. Thus, the traditional approaches for vehicle service can be inefficient for both the customers and vehicle service center.

To address at least a portion of the above identified inefficiencies, one or more aspects of the present application relate to the identification, deployment and execution of a suite of diagnostic and corrective services in response to user inputs prior to vehicle servicing. Illustratively, the deployment and execution of the diagnostic services may be combined or integrated with the management of user inputs related to requested services or observed vehicle parameters. Such integration can illustratively correspond to automated workflows for resulting services provided by a vehicle service provider. More specifically, aspects of the present application incorporate the automation that includes the following high-level steps implemented by a management component within the vehicle.

In accordance with an illustrative embodiment, the management component captures user concern/input related to a requested service or observed vehicle operational parameters. Illustratively, a customer (or user) may utilize one or more interfaces to capture inputs associated with observed vehicle attributes, self-selected service requests (e.g., 10,000-mile service), and the like. The captured user concern/input may be facilitated through utilization of mobile applications associated with individual users (e.g., mobile phone application), interfaces included in the vehicle, kiosks, personal computing devices, tablet computing devices, and the like.

Thereafter, the management component conducts diagnosis and filtering of the user input to identify a set of corrective actions to be performed and pre-service steps that may be required prior to service. The set of corrective actions and pre-service steps can be embodied as a suite of diagnostic services for execution by the vehicle or other computing device associated with the vehicle, such as a mobile computing device. Illustratively, the suite of diagnostic services is deployed for execution by at least one of the vehicles or associated computing devices. The suite of diagnostic services may be based on the user input and responsive to identified operating parameters. Additionally, the suite of diagnostic services may also be investigative in nature to measure different operating parameters or attempt to correlate an observed parameter with other operating parameters of the vehicle. For purposes of the present application, reference to a suite of diagnostic services is not intended to limit the functionality of individual services or applications, which can include collection of state information about the vehicle or environment, collection of state information regarding the user/operator, attempts to implement corrective or reparative actions, attempts to identify faulty or error conditions based on inputs provided to one or more components, and the like.

Additionally, the suite of diagnostic service may further process the processing results of other diagnostic services to determine whether a vehicle needs service. If it is determined that a vehicle needs service the management component may offer the user the option to approve service. The suite of diagnostic services may determine whether to offer service to the user/operator (or other related individual) based on the results of the diagnostic service. In some embodiments, the determination of whether to offer service to the vehicle can be based primarily on the results of the diagnostic service for the specific vehicle (e.g., whether the diagnostic service indicates that the specific vehicle needs service). The system may further base the option to approve service based on supply chain information. Supply chain information may include part availability or location specific part availability. The system may determine whether to offer service by comparing the severity of a condition to other users, in conjunction with part availability. In other embodiments, the determination of whether to offer service to the vehicle can be based on a relative comparison of results of the diagnostic service for a plurality of vehicles. In this embodiment, a service request can be based on a characterization of degree of need for servicing relative to other vehicles, especially in scenarios in which part availability or service location availability is limited. For example, assume a vehicle diagnostic processing result indicates that an offer for service is required but that the level of fault is characterized as “low priority” or “low impact.” Even though vehicle service may be ultimately required, the offer for service can be modified or configured to either defer to a next execution of the diagnostic suite execution (e.g., deferred service), or to process for future service beyond a minimum threshold. Such service modification can be done automatically (without any user input or notification) or in conjunction with user notification and input.

Upon completion of the diagnostic and filtering process, the management component obtains approval of the service request by a user and scheduling of service(s). For example, this can include access to user profile information indicative of pre-approval or approval thresholds. In other embodiments, this can include receive affirmative user inputs, such as manipulation of graphical interfaces, operating of vehicle controls (e.g., manipulation of a pedal, presentation of near field communication devices, selection of remote control/access inputs, etc.). In some embodiments, one or more aspects of the present application can include some form of feedback or processing results that are provided to the user indicative of the results of the execution of the suite of diagnostic services. For example, the feedback/processing results can be in the form of characterization of the results (e.g., excellent, good, bad, etc.). In other examples, the feedback/processing results can be in the form of individual values of the suite of diagnostic services, determined action group, potential causes of failures, or suggested severity level of potential faults. Subsequent to the approval and feedback process, a network-based management component associated with the physical service provider that may be conducting the service of the vehicle allocates and orders of parts and coordination of payment and supporting documentation. Illustratively, the outputs of the suite of diagnostic services can be utilized to pre-order parts, pre-arrangement physical services to be performed, and the like. Additionally, the outputs of the suite of diagnostic services can be utilized as inputs to estimate time to completion for the scheduled services.

By way of illustrative example, assume a user/operator provides some input via a vehicle interface of operational observations indicative of battery performance of the vehicle. In response, a suite of diagnostic services is deployed on the vehicle that captures various states of the electrical system, including battery system state, charging system state and operational use data related to the battery system. Based on the results of the suite of the execution of diagnostic services, a diagnostic service further determines that the needed service is a replacement of the vehicle's battery system. Based on the determination, the suite of diagnostic services can further characterize the need for a battery system replacement, including a characterization of the degree of fault, characterization of likelihood of failure, confidence factor in the diagnosis, and the like. Based on these processing results, a network-based management service can then provide a current state of service needs for battery systems replacements as well as inventory availability for battery systems and service location availability to implement a battery system replacement. The network-based management service can then provide inputs to the suite of diagnostic services regarding scheduling the replacement of the battery system and provide for user input and approval.

In accordance with some aspects of the present application, the capture of user concerns and inputs to cause the selection and deployment of the suite of diagnostic services can be illustratively captured through interactions with vehicle interfaces, mobile applications or other computing devices (e.g., kiosks, tablets, etc.). Such interactions can be based on predefined categories that are selectable by a user via an interface. Such interactions can also be based on a narrative type of input, such as via spoken language, typed comments, etc. that can be processed to extract key terms, etc. Illustratively, a network service provider can utilize third-party services to facilitate with the collection or processing of the user input. Still further, in some aspects, the user input can also include the collection of vehicle operational parameters, such as a frozen screen, frequent system resets, or low voltage. The user input may further comprise a response to a suggestion or prompt, for example the service management component may offer the user an option to run battery diagnostics in response to a sensed low voltage. The system may offer a suggestion based on a number of data points and it may be focused on certain systems, some examples vehicle characteristics that may be sensed or determined based on vehicle history, or a network-initiated suggestion. The user may respond with an indication to complete the suggested action. In an alternative example the service management component may offer the user an option to run system or infotainment diagnostics in response to frequent system resets or frozen screens.

In some embodiments, the suite of diagnostic services may be preloaded in the vehicle or software application(s) associated with the customers. In other embodiments, responsive to the action groups, the network service provider may transmit the suite of diagnostic services to the vehicle that have been modified or updated in accordance with the processed input. Still further, in other embodiments, a vehicle may maintain a generic or common set of diagnostic services that can be instantiated according to the user input. Specifically, individual iterations of the suite of diagnostic services may be implemented according to the action group or user input such that the diagnostic service(s) or execution of order/sequence is customized.

In some embodiments, the suite of diagnostic services can be continuously updated by the network service and transmitted to the vehicle. Such transmission may be accomplished responsive to a determination to deploy and execute one or more diagnostic services. Alternatively, a network service may be able to provide periodic or asynchronous updates to the vehicle or vehicle application in advance of the determination to deploy and execute diagnostic services.

In still further aspects of the present application, the vehicle or vehicle application may also maintain some historical information related to outputs or results of the suite of diagnostic services. The historical information may be utilized to determine trends or provide comparison points regarding operational status of the vehicle at measured points of time. Such historical information may be provided to the service provider, especially if the vehicle has not been previously serviced. For example, a vehicle service repair for a particular system (e.g., charging components) may include the results of one or more diagnostic services related to the operational attributes of the charging components in a current state, but also results from previous instantiations of the same or similar diagnostic services.

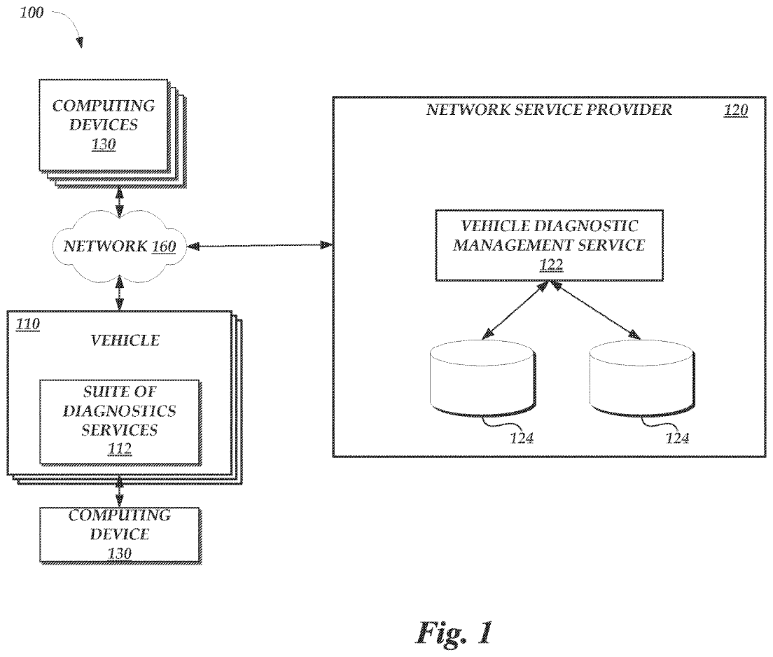

FIG. 1 depicts a block diagram of an illustrative environment of a system 100 for providing configuration and management of services associated with vehicles based on customer input in accordance with one or more aspects of the present disclosure. The system 100 can comprise a network 160, the network connecting a set of vehicles 110, a network service provider 120, and one or more customer devices 130. The components may correspond to software modules implemented or executed by one or more external computing devices, which may be separate stand-alone external computing devices. Accordingly, the components of the network service provider 120 should be considered as a logical representation of the service, not requiring any specific implementation on one or more external computing devices.

The customer device 130, as depicted in FIG. 1, can be any computing device, such as a desktop, laptop, personal computer, tablet computer, wearable computer, server, personal digital assistant (PDA), hybrid PDA/mobile phone, mobile phone, smartphone, set-top box, voice command device, digital media player, and the like. The customer device 130 may execute an application (e.g., a browser, a stand-alone application, etc.) that allows a user to access interactive user interfaces, view images, analyses, aggregated data, and/or the like as described herein. In some embodiments, the customer device 130 can be implemented in conjunction with the vehicle 110 and may provide some functionality associated with the vehicle 110. For example, the vehicle 110 may perform one or more functions utilizing the customer device 130 in conjunction with utilizing the vehicle's resources, such as the vehicle's processors and memory.

Network 160, as depicted in FIG. 1, can connect the vehicles 110, customer devices, 130, and network service provider 120. The network 160 can connect any number of devices. In some embodiments, the network service provider 120 provides network-based services to customer devices 130 via a network. A network service provider implements network-based services and refers to a large, shared pool of network-accessible computing resources (such as compute, storage, or networking resources, applications, or services), which may be virtualized or bare-metal. The network service provider can provide on-demand network access to a shared pool of configurable computing resources that can be programmatically provisioned and released in response to customer commands. These resources can be dynamically provisioned and reconfigured to adjust to the variable load. The concept of “cloud computing” or “network-based computing” can thus be considered as both the applications delivered as services over the network and the hardware and software in the network service provider that provide those services.

A network 160 can comprise any combination of wired and/or wireless networks, such as one or more direct communication channels, local area network, wide area network, personal area network, and/or the Internet, for example. In some embodiments, communication between the vehicle 110 and the customer device 130 may be performed via a short-range communication protocol, such as Bluetooth, Bluetooth low energy (“BLE”), and/or near field communications (“NFC”). Communication between the vehicle 110 and the network service provider 120 can occur via network 160, such as via one or more secured networks, such as a local area network that communicates securely via the Internet with the network service provider 120. However, networks 160 may include some or all of the same communication protocols, services, hardware, etc. Thus, although the discussion herein may describe communication between the vehicle 110 and the customer device 130 via the network 160 and communication between the vehicle 110 and the network service provider 120 via the network 160, communications of the devices are not limited in this manner. The various communication protocols discussed herein are merely examples, and the present application is not limited thereto.

In some embodiments, the network 160 can utilize a high-speed 4G LTE or other wireless communication technology, such as 5G communications. Thus, in some embodiments, the network 160 may include one or more wireless networks, such as a Global System for Mobile Communications (GSM) network, a Code Division Multiple Access (CDMA) network, a Long Term Evolution (LTE) network, or any other type of wireless network. Network 160 can use protocols and components for communicating via the Internet or any of the other aforementioned types of networks. For example, the protocols used by the networks 160 may include Hypertext Transfer Protocol (HTTP), HTTP Secure (HTTPS), Message Queue Telemetry Transport (MQTT), and Constrained Application Protocol (CoAP), and the like. Protocols and components for communicating via the Internet or any of the other aforementioned types of communication networks are well known to those skilled in the art and, thus, are not described in more detail herein.

As applied to various aspects of the present application, the set of vehicles 110 correspond to one or more vehicles configured with a suite of diagnostic services 112 for execution by the vehicle 110 or other computing device associated with the vehicle, such as a mobile computing device 130. As described above, reference to a suite of diagnostic services 112 is not intended to limit the functionality of individual services or applications, which can include collection of state information about the vehicle or environment, collection of state information regarding the user/operator, attempts to implement corrective or reparative actions, attempts to identify faulty or error conditions based on inputs provided to one or more components, and the like.

Illustratively, the network service provider 120 can include a vehicle network-based management component 122 that can provide functionality responsive to processing customer input to provide configuration and management of services associated with vehicle based on the processed customer input as applied to aspects of the present application. As described above, the network-based management component 122 may be associated with the physical service provider that may be conducting the service of the vehicle allocates and facilitates inputs to inventory or parts ordering systems to cause orders of parts and coordination of payment and supporting documentation. Additionally, the network-based management component 122 may further process processing results from multiple vehicles 110 to facilitate prioritization, filtering or other relative comparisons of diagnostic processing as described herein. The network-based service can include a plurality of datastores 124 for maintaining various information associated with aspects of the present application. The network-based management component 122 in FIG. 1 is logical in nature and can be implemented in the network service provider 120 in a variety of manners.

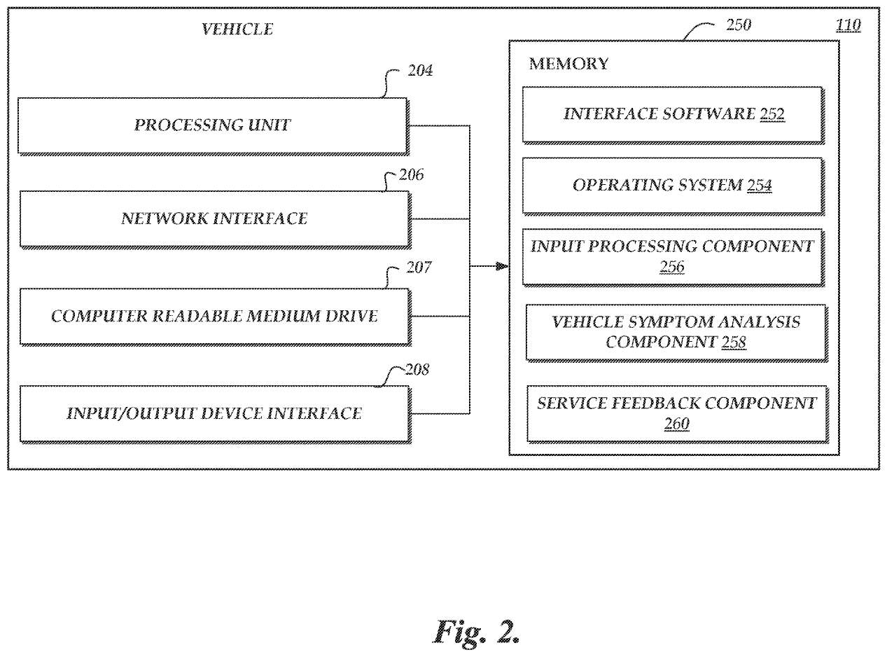

With reference now to FIG. 2, an illustrative architecture for implementing the suite of diagnostic services 112 in a vehicle 110 on one or more local resources or a network service will be described. The suite of diagnostic services 112 may be part of components/systems that provide functionality associated with a vehicle service provider and the like.

The architecture of FIG. 2 is illustrative in nature and should not be construed as requiring any specific hardware or software configuration for the vehicle 110 (or computing device 130 associated with a vehicle). The general architecture of the vehicle 110 depicted in FIG. 2 includes an arrangement of computer hardware and software components that may be used to implement aspects of the present disclosure. As illustrated, the vehicle 110 includes a processing unit 204, a network interface 206, a computer readable medium drive 207, and an input/output device interface 208, all of which may communicate with one another by way of a communication bus. The components of the vehicle 110 may be physical hardware components or implemented in a virtualized environment.

The network interface 206 may provide connectivity to one or more networks or computing systems, such as the network of FIG. 1. The processing unit 204 may thus receive information and instructions from other computing systems or services via a network. The processing unit 204 may also communicate to and from memory 250 and further provide output information for an optional display (not shown) via the input/output device interface 208. In some embodiments, the vehicle 110 may include more (or fewer) components than those shown in FIG. 2.

The memory 250 may include computer program instructions that the processing unit 204 executes in order to implement one or more embodiments. The memory 250 generally includes RAM, ROM, or other persistent or non-transitory memory. The memory 250 may store interface software 252 and an operating system 254 that provides computer program instructions for use by the processing unit 204 in the general administration and operation of the network-based management component 122. The memory 250 may further include computer program instructions and other information for implementing aspects of the present disclosure.

The memory 250 can include an input processing component 256 to process customer input. In these embodiments, the input processing component 256 can correspond to one or more machine learned models to process natural human language, such as a narrative language input, to be used for identifying one or more symptoms related to a vehicle. In some embodiments, the machine learned model.

The memory 250 can also include an input processing component 258. In some embodiments, the customer, by utilizing the customer device 130, can provide customer input, and the input processing component 256 can filter the customer input to be used for predicting one or more symptoms related to the customer input. For example, the input processing component 258 extract one or more key terms from the customer input, where the key terms can be used to predict symptoms. In these embodiments, the customer input can be provided to the input processing component 258 in the form of a text or in a context of verbal expression.

In some embodiments, the customer may provide the customer input in a form of a natural language. In these embodiments, the customer input can be narrative. For example, the customer may type one or more sentences related to the vehicle or speak about the vehicle in the context of natural human language. In some embodiments, the input processing component 256 process these customer input to determine one or more customer input that can be used for predicting the vehicle symptoms. For example, the customer input can be “my car has a yellow border around the touchscreen.” In this example, the input processing component 256 may filter the customer input and determine “a touch screen malfunction.” In another example, the customer input can be “my car pulls to the left on the highway.” In this example, the input processing component 258 processes the customer input and determine the customer input as “wheels are not aligned.”

In some embodiments, the input processing component 256 can be configured to utilize a machine learned model to process the natural language provided as customer input. For example, if the customer input is “my car stinks,” a machine learned model may process the customer input and determine the customer input as “heating ventilation and air conditioning (HAVC) system malfunction.”

In some embodiments, the input processing component 256 receives the customer input as a set of vehicle symptoms. In these embodiments, the customer device 130 may provide a list of vehicle symptoms, and the customer may select one or more symptoms from the list of vehicle symptoms. For example, the customer device 130 may have a list of predefined vehicle symptoms, such as “engine check light on,” “vehicle vibration,” “safety feature inoperable,” “battery malfunction,” etc. In this example, the customer may select one or more symptoms from the list of predefined vehicle symptoms.

The memory 250 can also include a vehicle symptom analysis component 258 that illustratively corresponds to the suite of diagnostic services 112. As described above, reference to a suite of diagnostic services 112 is not intended to limit the functionality of individual services or applications, which can include collection of state information about the vehicle or environment, collection of state information regarding the user/operator, attempts to implement corrective or reparative actions, attempts to identify faulty or error conditions based on inputs provided to one or more components, and the like. As will be described below, in some embodiments, user input may be associated with one or more action groups that facilitate logical grouping of natural language inputs to potential symptoms for vehicle servicing. In turn, suites of diagnostic services 112 may be associated with action groups in a manner to collect necessary information, attempt corrective actions, and provide additional inputs based on the processing user input mapped to an action group.

The memory 250 can also include a service feedback component 260 for providing feedback (or feedback characterization) to the customer. As described above, the feedback can illustratively include requests for additional diagnostic services or user observations. In other aspects, feedback can include approval or inputs related to service scheduling, part ordering, financial commitments, and the like.

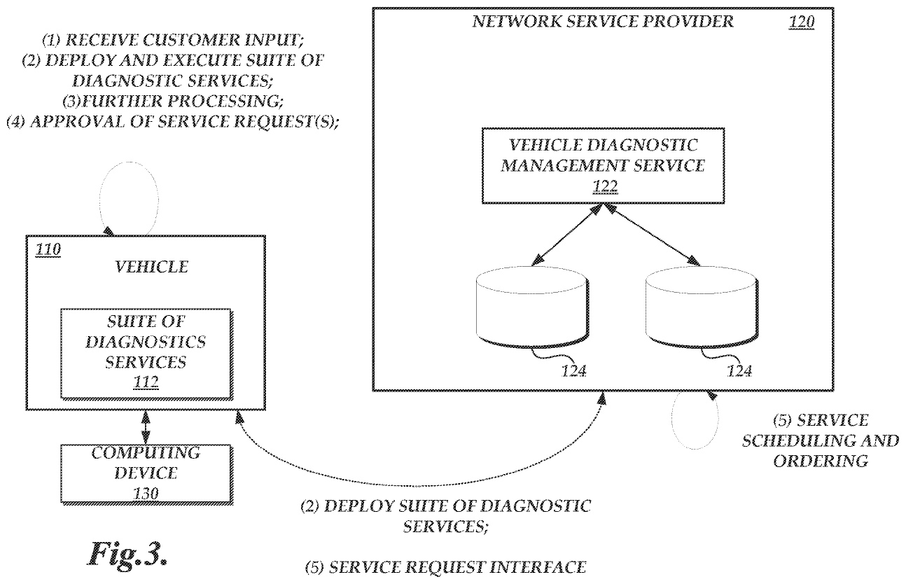

Turning now to FIG. 3, illustrative interactions of the components of the system 100 to provide vehicle service based on the processed result of a customer input will be described. For purposes of the illustration, it can be assumed that a network service provider 120 has been configured to implement a network-based management component 122 on behalf of a set of customers. The present application is not intended to be limited to any particular type of service provider or the number of individual services that may be accessed or generate processing results as part of an execution of an application on behalf of customers. Furthermore, the present application is not intended to be limited to the number of network service providers, as depicted in FIG. 1.

As shown in FIG. 3, at (1), a customer can provide customer input to the network-based management component 122 by transmitting the customer input via a customer device 130. The customer input corresponds to texts, images, and/or natural language. In some aspects, the customer input can also include the collection of vehicle operational parameters that may be applicable or relevant to the customer input, such as sensor/instrument values, warnings or notifications, recommended action items, and the like.

Illustratively, the customer can provide the customer input by utilizing an interface in the vehicle 110 (such as an integrated display screen or microphone) or via the customer device 130 that is associated with the vehicle 110. The vehicle or customer device 130 may execute an application (e.g., a browser, a stand-alone application, etc.) that allows a customer to input the customer input and access interactive user interfaces, view images, analyses, aggregated data, and/or the like as described herein.

In some embodiments, the customer input can be provided to the network-based management component 122 in the form of a text or in the context of verbal expression. In some embodiments, the customer may provide the customer input in the form of a natural language. In these embodiments, the customer input can be narrative. For example, the customer may type one or more sentences related to the vehicle or speak about the vehicle in the context of natural human language.

By way of illustrative example, the user input may be characterized as a likelihood of pertaining to one or more of a set of defined action groups. Individual action groups define an associated symptom/cause and a confidence value of mapping the symptom/cause with the captured user input. The individual action group then defines one or more corrective or responsive actions that can be implemented by vehicle, technician, additional third parties, and the like. Accordingly, based on the mapping of input to action groups, the network service provider can define and execute actions (e.g., diagnostic actions, information collection actions, or corrective actions) that may be utilized to complete the requested service or addressed the observed vehicle parameter. Although described herein for purposes of illustration, the utilization of action groups or aspects of actions groups is not required in some embodiments.

Illustratively, the network service provider can select an associated action group by first applying some form of threshold or filtering any action groups that do not meet a minimum threshold of confidence values. For example, action groups not having a confidence value of greater than 60%, 65%, 70%, 75%, or other specified value may be removed from consideration. The confidence values may be attributable/assigned to action group symptoms based on manual input, machine learning implementations and the like and may be updated based on historic information based on individual experiences unique to a customer or vehicle, organizational experiences unique to defined subset of individuals or vehicles, or more universally applicable thresholds. Thereafter, the remaining potentially applicable action groups may be ranked or sorted in a manner to select a most likely applicable action group. The sorting or ranking may be based strictly on numerical principles or via a weighted scheme, such as weighting based on historical interactions with the user, vehicle, sets of vehicles, sets of users, or combination thereof. In some embodiments, if the confidence values of any of the action groups do not meet a threshold (which may be the same or different threshold from the filtering threshold), the network service provider can cause the system to gather supplemental user inputs or perform initial diagnosis prior to selecting an action group.

Each individual action group (once selected) then defines a set of actions, such as diagnostic, informative or corrective actions, which facilitate the service workflow based on the user input that can be embodied in the suite of diagnostic services 112. For example, the suite of diagnostic services 112 can include executing automated information collection tools/apps that are able to collect vehicle data and identify data patterns. In another example, the actions can include executing automated diagnostic tools that can executed by a vehicle. The outputs generated by the suite of diagnostic service can be accessible by the technician as provided by the vehicle, such as advanced transmission from a vehicle or service application.

In some embodiments there may be a single or more action groups that are mapped to initial user input. As a result of mapping to the one or more action groups the service management component may determine additional action groups. The additional action groups may be determined based on the confidence value of the first action group, or the other action groups. For example, if the network-based management component 122 determines there is a 50% confidence it is action group 1, a 45% confidence it is action group 2, and a 5% confidence it is action group 3, the service management component may execute all or a portion of actions (e.g., diagnostic actions, information collection actions, or corrective actions) associate with group 1 and action group 2. The network-based management component 122 may implement diagnostics associated with both action group 1 and action group 2 to determine the root cause of the issue. The network-based management component 122 may further analyze the corrective actions associates with each group, e.g., the parts and labor required for action group 1and action group 2 in determining whether to carry out the physical implementation of action group 1 and action group 2.

In some embodiments the network-based management component 122 may map to additional action groups or actions based on the determined action group, or the diagnostic actions, information collection actions, or corrective actions of the action group. The additional action groups may be unrelated to the initial user input. The additional action groups may determine based on the criteria associated with the action group including diagnostics, vehicle history, vehicle age, and the service required for the determined action group(s).

In some embodiments, some action groups may specify a wide variety of actions, which may be in logical order (e.g., information gathering/diagnostic/repair). In other embodiments, an action group may be limited to specific types of actions, such as diagnostic services that are dependent on results of other diagnostic services. The actions can also be structured or ordered in a manner such that the outcome/result of a preceding action may have dependency or influence on the subsequent actions (e.g., values from information gather may dictate which diagnostic actions are selected). Accordingly, in some aspects of the present application, the selection of the suite of diagnostic services, order of execution and parameters that are passed between executed diagnostic services can based on the user input and determined action groups.

Action groups may be illustratively mapped or clustered based on the organization of a vehicle, such that actions groups may be able to be matched to the major organizational groups of a vehicle (e.g., power train, HVAC, etc.). Other action groups may be mapped to individual components or services. Still further action groups may be continuously monitored, adjusted or updated based on processing results by the network service provider. For example, an action group that is rarely selected may modified or blended. In another example, an action group that does not result in appropriate service experience or an incorrect diagnosis, may be eliminated, updated, or divided.

At (2), the network-based management component 122 causes the vehicle to conduct diagnosis and filtering of the user input to identify a set of corrective actions to be performed and pre-service steps that may be required prior to service. The set of corrective actions and pre-service steps can be embodied as a suite of diagnostic services 112 for execution by the vehicle or other computing device associated with the vehicle, such as a mobile computing device. Illustratively, the suite of diagnostic services is deployed for execution by at least one of the vehicles or associated computing devices. The suite of diagnostic services may be based on the user input and responsive to identified operating parameters. Additionally, the suite of diagnostic services may also be investigative in nature to measure different operating parameters or attempt to correlate an observed parameter with other operating parameters of the vehicle.

At (3), the suite of diagnostic service may further process the processing results of other diagnostic services to determine whether a vehicle needs service. If it is determined that a vehicle needs service the management component may offer the user the option to approve service. The suite of diagnostic services may determine whether to offer service to the user/operator (or other related individual) based on the results of the diagnostic service. In some embodiments, the determination of whether to offer service to the vehicle can be based primarily on the results of the diagnostic service for the specific vehicle (e.g., whether the diagnostic service indicates that the specific vehicle needs service). The system may further base the option to approve service based on supply chain information. Supply chain information may include part availability or location specific part availability. The system may determine whether to offer service by comparing the severity of a condition to other users, in conjunction with part availability. In other embodiments, the determination of whether to offer service to the vehicle can be based on a relative comparison of results of the diagnostic service for a plurality of vehicles. In this embodiment, a service request can be based on a characterization of degree of need for servicing relative to other vehicles, especially in scenarios in which part availability or service location availability is limited. For example, assume a vehicle diagnostic processing result indicates that an offer for service is required but that the level of fault is characterized as “low priority” or “low impact.” Even though vehicle service may be ultimately required, the offer for service can be modified or configured to either defer to a next execution of the diagnostic suite execution (e.g., deferred service), or to process for future service beyond a minimum threshold. Such service modification can be done automatically (without any user input or notification) or in conjunction with user notification and input.

Upon completion of the diagnostic and filtering process, at (4), the network-based management component 122 obtains approval of the service request by a user and scheduling of service(s). For example, this can include access to user profile information indicative of pre-approval or approval thresholds. In other embodiments, this can include receiving affirmative user inputs, such as manipulation of graphical interfaces, operating of vehicle controls (e.g., manipulation of a pedal, presentation of near field communication devices, selection of remote control/access inputs, etc.). In some embodiments, one or more aspects of the present application can include some form of feedback or processing results that are provided to the user indicative of the results of the execution of the suite of diagnostic services. For example, the feedback/processing results can be in the form of characterization of the results (e.g., excellent, good, bad, etc.). In other examples, the feedback/processing results can be in the form of individual values of the suite of diagnostic services, determined action group, potential causes of failures, or suggested severity level of potential faults.

Subsequent to the approval and feedback process, at (5), the network-based management component 122 can interface with an inventory and ordering system that allocates and orders parts and coordinates payment and supporting documentation. Illustratively, the outputs of the suite of diagnostic services can be utilized to pre-order parts, pre-arrangement physical services to be performed, and the like. Additionally, the outputs of the suite of diagnostic services can be utilized as inputs to estimate time to completion for the scheduled services.

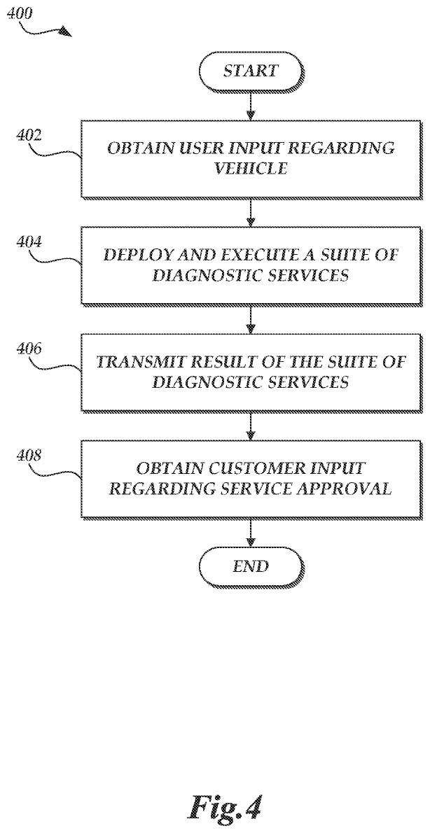

FIG. 4 is a flow chart describing a routine 400 for providing vehicle diagnostic management service according to one or more embodiments as disclosed herein. Routine 400 begins at block 402, capturing at least one user input. The user input may be user-initiated, e.g., the user reports an issue with the vehicle, the user input may be management component initiated, e.g., the management component suggestion to a user which the user may respond to, or some combination. The user input may be captured in an associated vehicle, on a mobile device, or through any related method. The user may make a verbal command, verbal phrase, enter a touch pattern, type a phrase, type a command, or any other related form of input. The input may be the reporting of an issue with a vehicle, such as ‘screen frozen’, ‘car won't unlock’, or alternatively the management component may show a message saying, ‘potential battery issue, run diagnostics?’At block 404, the vehicle deploys and executes of a suite of diagnostic services 112 responsive to the captured at least one user input. The suite of diagnostic services 112 may comprises identifying a set of corrective actions to be performed or pre-service steps. The corrective action may also be determined by first identifying an action group. The action group or action groups may be based on the user input and may be determined prior to block 404. The determined action group may determine the suite of diagnostic service, the action group may include communication with a network or corrective actions. The analysis, processing, and or determination associated with execution of a suite of diagnostics may occur at the vehicle, or it may occur on or in conjunction with the network service provider.

The suite of diagnostic services 112 may be investigative in nature to measure different operating parameters or attempt to correlate an observed parameter with other operating parameters of the vehicle. The suite of diagnostic services may be action oriented in nature, such as updating software, resetting a system, or adjusting operating parameters. The suite of diagnostic services of the user input to identify a set of corrective actions to be performed may include determining action groups based on the user input. The suite of diagnostic services responsive to the user input to identify a set of corrective actions to be performed may include obtaining at least one diagnostic service from a service provider. The diagnosis and filtering (suite of diagnostic services) of the user input to identify a set of corrective actions to be performed may include modifying at least one diagnostic service.

The suite of diagnostic services may comprise communicating with a network service provider. The service management component may communicate with a network service provider to determine an action group. The network service provider can further execute actions including diagnostic actions, information collection actions, or corrective actions.

Block 406 comprises transmitting the results of the suite of diagnostic services. The results of the suite of diagnostic services may be transmitted to the network-based management component 122. Additionally, or alternatively, the results of the suite of diagnostic services may be transmitted to a service shop, or a technician.

Block 408 comprises obtaining approval of the services requested from the user. Approval may be obtained via a user device such as a mobile phone or via an interface in the vehicle. Block 408 may further comprise scheduling a service. The service may be scheduled based on part availability, shop availability, and urgency of the service request.

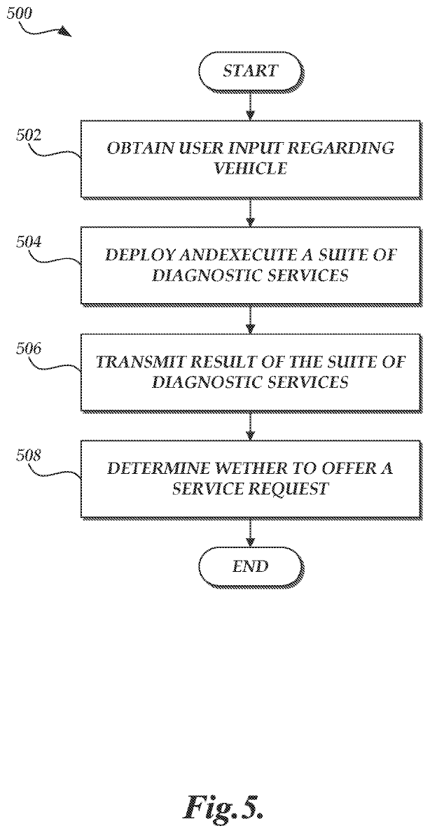

FIG. 5 is a flow chart describing a routine 500 for providing vehicle diagnostic management service according to one or more embodiments as disclosed herein Routine 500 begins at block 502, capturing at least one user input. The capturing of the user input 502 may be similar or the same as block 402 (FIG. 4).

At block 504, the vehicle 110 deploys and executes a suite of diagnostic services 112 responsive to the captured at least one user input. The suite of diagnostic services 112 may be used to determine a corrective action. The suite of diagnostic services may be selected by first identifying an action group in some embodiments. The action group or action groups may be based on mapping natural language inputs provided by a user to potential symptoms. In other embodiments, the suite of diagnostic services may be configured to map directly to user input (such as via touch interfaces) or hierarchically structured to iterate through various diagnosis. Through a suite of diagnostic services 112, including communication with a network 160, an action group and or corrective actions associate with an action group may be determined.

The results of the suite of diagnostic services may be transmitted in block 506 It should be understood that block 504 and block 506 may be in either order and or may be combined. The transmitted results may be sent to a technician or a network as described in regard to block 406. The results of the suite of diagnostic services may comprise a severity of the issue and or severity of the corrective actions.

Block 508 comprises determining whether to offer a first service request. The determination of whether to offer a first service request may be based on the severity of the issue, the corrective actions required, the parts required, part availability, shop availability, the results of the suite of diagnostic services, and a number of other factors. The determination may be made by the network. The network may compare the severity or urgency of the issue to the severity or urgency of an issue associated with another user's vehicle to determine who to prioritize. This type of determination is most useful when there are a limited number of parts available. The system may further determine or modify the corrective actions based on other another vehicle(s) 110 in the network and part availability. For example, the vehicle 110 may have a hardware issue that requires a new infotainment unit, however there are a limited number of infotainment units available. Thus, software related corrective actions may be prescribed to the users care until the parts are available or the severity of the issue rises to a point where the user's vehicle is to be prioritized.

Determining whether to offer a first service request may further be based on a second issue. The second issue may be associated with a second action group and a second corrective action(s). The network may determine no to offer a first service request until parts or time is available to complete the second service request, such that both the first service request and the second service request may be completed at the same time.

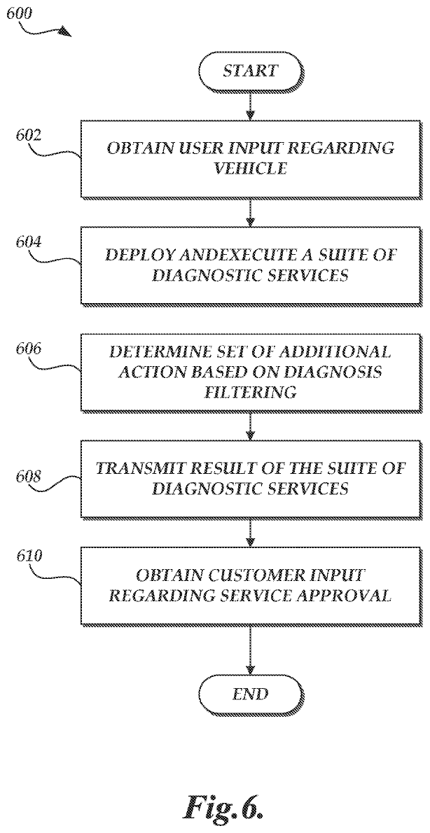

FIG. 6 is a flow chart describing a routine 600 for providing vehicle diagnostic management service according to one or more embodiments as disclosed herein. Routine 600 begins at block 602, capturing at least one user input. The capturing of the user input may be similar or the same as blocks 402 and 502 (FIGS. 4 and 5).

Block 604 comprises causing, at a vehicle, execution of a suite of diagnostic services responsive to the captured at least one user input. As described above, the suite of diagnostic services 112 may be used to determine vehicle state information, attempt one or more corrective action(s), or otherwise provided additional diagnosis information. The analysis, processing, and or determination associated with execution of a suite of diagnostic services 112 may occur at the vehicle, or it may occur on or in conjunction with the network service provider.

Block 606 comprises determining a set of additional actions based on the processing result of the initial suite of diagnostic services 112 or additional user inputs. Block 606 may comprise additional diagnostic services responsive to attempted corrective actions. The additional actions may be related to corrective actions determined during the diagnosis services and filtering of the user input. The additional actions may be determined by analyzing the corrective actions.

For example, the corrective actions required may be replacement of a wheel bearing. The replacement of a wheel bearing may require the removal of the brake assembly and the wheel. Based on the vehicle age, mileage, use data, last service, and other factors the system may determine whether the brakes require service or will require service in the near future. Therefore, it may be determined that the brakes should also be replaced based on the corrective action associated with the diagnosis services and filtering of the user input. In an alternative example, the additional action may be entirely unrelated. For example, the corrective action required may be a wheel bearing. Based on the determination that the vehicle will need service additional diagnostics covering the entirety ort a portion of the vehicle may be run.

In one example it may be determined based on sensor data, age, usage, voltage, or other criteria that the battery should also be replaced when the vehicle is undergoing its corrective action. This step allows for the optimization of shop time and labor. The system may analyze overlapping service requirements to determine if additional components should be replaced during a service of a first component. In some embodiments, block 606 is conducted after obtaining approval of a service request 610 or after determining a service request should be offered.

Block 608 comprises transmitting the results of the suite of diagnostic services. The results of the suite of diagnostic services may be transmitted to a cloud, network, or a processor. The results of the suite of diagnostic services may be transmitted to a service shop, or a technician. The results may further be transferred to both.

Block 610 comprises obtaining approval of the services requested from the user. Approval may be obtained via a user device such as a mobile phone or via an interface in the vehicle. Block 608 may further comprise scheduling a service. The service may be scheduled based on part availability, shop availability, and urgency of the service request.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of vehicle data or vehicle processes. However, one skilled in the relevant art will appreciate that the aspects of the present application are not necessarily limited to application to any particular type of vehicle data, data communications or illustrative interaction between third parties, customer and a network service provider.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting on the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A system for managing vehicle servicing comprising:
a first computing device associated with a vehicle, the first computing device having a processor and a memory that execute computer-readable instructions that causes the first computing device to:
capture at least one user input, wherein the at least one user input corresponds to at least one of a requested service or an observed vehicle operational parameter;
execute a suite of diagnostic services responsive to the captured at least one user input;
transmit at least one processing result associated with the suite of diagnostic services;
a second computing device associated with a network-based management component, the second computing device having a processor and a memory that execute computer-readable instructions that cause the network-based management component to:
obtain the transmitted at least one processing result associated with the suite of diagnostic services; and
determine whether to offer a service request based on the transmitted processing result, wherein the first computing device is further operable to receive a determined offer for a service request.

2. The system of claim 1, wherein computer-readable instructions further cause the network-based management component to obtain approval of the service request by a user.

3. The system of claim 1, wherein execution of the suite of diagnostic services comprises identifying a corrective action or pre-service steps to be performed.

4. The system of claim 3, wherein determining whether to offer the service request is based on availability of a vehicle component, wherein a vehicle component is based on the corrective action.

5. The system of claim 1, wherein the first computing device is integrated into the vehicle.

6. A method for managing vehicle servicing comprising:
capturing at least one user input, wherein the at least one user input corresponds to at least one of a requested service or an observed vehicle operational parameters;
causing, at a vehicle, execution of a suite of diagnostic services responsive to the captured at least one user input;
transmitting, at the vehicle, at least one processing result associated with execution of the suite of diagnostic services; and
obtaining approval of a service request by a user and scheduling of at least one service based, at least in part, on the at least one processing result.

7. The method of claim 6, wherein execution of a suite of diagnostic services comprises identifying a set of corrective actions to be performed or pre-service steps.

8. The method of claim 7, wherein execution of a suite of diagnostic services comprises executing the set of corrective actions to be performed or the pre-service steps.

9. The method of claim 6, wherein causing, at the vehicle, execution of a suite of diagnostic services includes obtaining at least one diagnostic service from a service provider.

10. The method of claim 6, wherein causing, at the vehicle, execution of a suite of diagnostic services includes modifying at least one diagnostic service.

11. The method of claim 6, wherein the suite of diagnostic services corresponds to a sequence of diagnostic services.

12. The method of claim 6, further comprising maintaining historical information corresponding to a plurality of executions of the suite of diagnostic services.

13. A method for managing vehicle servicing comprising:
receiving at least one of a user input related to a vehicle component;
causing, at a vehicle, execution of a suite of diagnostic services responsive to the received at least one user input;
transmitting at least one processing result associated with execution of the suite of diagnostic services; and
determining whether to offer a first service request.

14. The method of claim 13, wherein the vehicle component is a battery system.

15. The method of claim 13, further comprising prompting a user to input the user input.

16. The method of claim 13, further comprising generating a suggestion of additional vehicle diagnostics based on the at least one processing result associated with execution of the suite of diagnostic services.

17. The method of claim 13, wherein execution of a suite of diagnostic services comprises identifying a corrective action or pre-service steps to be performed.

18. The method of claim 17, wherein determining whether to offer the first service request is based on availability of a vehicle component, wherein a vehicle component is based on the corrective action.

19. The method of claim 17, wherein determining whether to offer a first service request is based on a severity of a first issue in comparison to a plurality of other users, where the first issue is associated with the corrective action.

20. The method of claim 13, further comprising obtaining approval of the service request by a user.
